(19) United States
(12) Patent Application Publication
(10) Pub. No.: US 2006/0079207 A1
(43) Pub. Date: Apr. 13, 2006

(54) Method for configuring hold entertainment

(75) Inventors: Hitan S. Kamdar, Utica, MI (US); Russell A. Patenaude, Macomb Township, MI (US); Anthony J. Sumcad, Southfield, MI (US); Shpetim S. Veliu, Livonia, MI (US)

Correspondence Address: Cardinal Law GRP, Ste 2000, 1603 Orrington Ave, Evanston, IL, 60201, US

(73) Assignee: General Motors Corporation

(21) Appl. No.: 10/960,524

(22) Filed: Oct. 7, 2004

(51) Int. Cl. H04Q 7/20

(52) U.S. Cl. 455/412.1; 340/7.52

(57) ABSTRACT

A method for configuring hold entertainment includes monitoring a wireless connection between a telematics unit and a call center for a data input and muting a source input responsive to detection of the data input.

### FIELD OF THE INVENTION

This invention relates generally to methods of configuring hold entertainment.

### BACKGROUND OF THE INVENTION

Telematics services often must put a user “on hold” during a telematics connection. In an effort to minimize customer frustration, many services provide hold music to entertain and pacify customers during the time that the customer is on hold. Unfortunately, the customer is frequently dissatisfied with the hold music provided by the service, and may become dissatisfied with the service itself in response to their dissatisfaction with the hold music. Many customers prefer to choose their own entertainment.

In the past, establishing a telematics connection has resulted in muted entertainment services to avoid transmitting a user's entertainment to the call center and in an effort to maximize comprehension of a conversation between the user and an advisor.

It is therefore desirable to provide a method for configuring hold entertainment that overcomes the limitations, challenges, and obstacles described above.

### SUMMARY OF THE INVENTION

The invention provides a method of configuring hold entertainment. The method includes monitoring a wireless connection between a telematics unit and a call center for a data input. The method further includes muting a source input in response to the detection of a data input.

Another aspect of the invention provides a computer readable medium for configuring hold entertainment including computer readable code for monitoring a wireless connection between a telematics unit and a call center for a data input. The medium further includes computer readable code for muting a source input in response to the detection of a data input.

Yet another aspect of the invention provides a system for configuring hold entertainment. The system includes means for monitoring a wireless connection between a telematics unit and a call center for a data input. The system further includes means for muting a source input in response to the detection of a data input.

The aforementioned and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of one embodiment of a system for configuring hold entertainment in accordance with the present invention;

FIG. 2 is a flowchart representative of one embodiment of a method for configuring hold entertainment in accordance with the present invention;

FIG. 3 is a flowchart representative of one embodiment of a method for configuring hold entertainment in accordance with the present invention;

FIG. 4 is a flowchart representative of one embodiment of a method for configuring hold entertainment in accordance with the present invention;

FIG. 5 is a flowchart representative of one embodiment of a method for configuring hold entertainment in accordance with the present invention; and

FIG. 6 is a flowchart representative of one embodiment of a method for configuring hold entertainment in accordance with the present invention.

### DETAILED DESCRIPTION OF THE PRESENTLY PREFERRED EMBODIMENTS

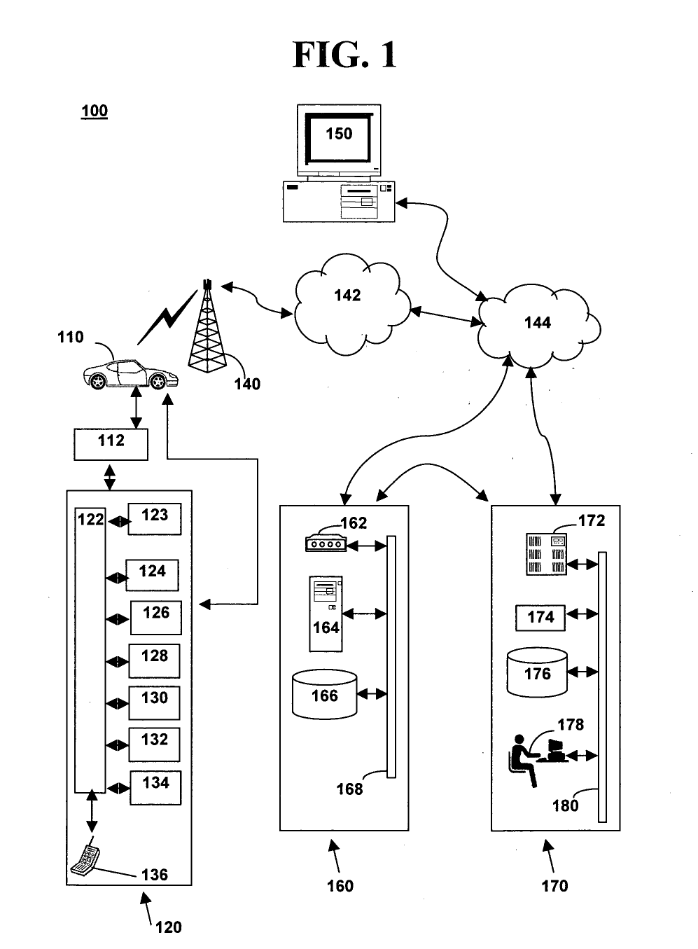

FIG. 1 illustrates one embodiment of a system for configuring hold entertainment in accordance with the present invention at 100. System 100 includes a mobile vehicle communication unit (MVCU) 110; a vehicle communication network 112; a telematics unit 120; one or more wireless carrier systems 140; one or more communication networks 142; one or more land networks 144; one or more client, personal, or user computers 150; one or more web-hosting portals 160; and one or more call centers 170. In one embodiment, MVCU 110 is implemented as a mobile vehicle equipped with suitable hardware and software for transmitting and receiving voice and data communications. In an example, a display is embedded in MVCU 110. The display is a dialed digital display such as a radio unit, radio head or an instrument panel. MVCS 100 may include additional components not relevant to the present discussion.

MVCU 110 is referred to as a mobile vehicle in the discussion below. In operation, MVCU 110 may be implemented as a motor vehicle, a marine vehicle, or as an aircraft. MVCU 110 may include additional components not relevant to the present discussion.

Vehicle communication network 112 routes signals between various units or modules of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a processor 122 connected to an in-vehicle audio speech-generating source 123, a wireless modem 124, a global positioning system (GPS) unit 126, an in-vehicle memory 128, a microphone 130, one or more speakers 132, source device 134, and an embedded or in-vehicle mobile phone 136. In other embodiments, telematics unit 120 may be implemented without one or more of the above listed components such as, for example, speakers 132. Telematics unit 120 may include additional components not relevant to the present discussion. In one embodiment, source device 134 is a CD player, terrestrial radio receiver, satellite radio receiver, DVD player, MP3 player, a media player, or other entertainment device. In one embodiment, source device 134 is within MVCU 110. In yet another embodiment, source input 134 is remote from the MVCU 110, and is in communication with the MVCU via a wireless connection.

In one embodiment, processor 122 is implemented as a microcontroller, microprocessor, controller, host processor, or vehicle communications processor. In an example, processor 122 is implemented as an application-specific integrated circuit (ASIC). In another embodiment, processor 122 is implemented as a processor working in conjunction with a central processing unit (CPU) performing the function of a general purpose processor. GPS unit 126 provides longitude and latitude coordinates of the vehicle responsive to a GPS broadcast signal received from one or more GPS satellite broadcast systems (not shown). In-vehicle mobile phone 136 is a cellular-type phone such as, for example, an analog, digital, dual-mode, dual-band, multi-mode or multi-band cellular phone.

Processor 122 executes various computer programs that control programming and operational modes of electronic and mechanical systems within MVCU 110. Processor 122 controls communications (e.g., call signals) between telematics unit 120, wireless carrier system 140, and call center 170. In one embodiment, a voice-recognition application is installed in processor 122 that can translate human voice input through microphone 130 to digital signals. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160, and call center 170.

Client, personal, or user computer 150 includes a computer usable medium to execute Internet browser and Internet-access computer programs for sending and receiving data over land network 144 and, optionally, wired or wireless communication networks 142 to web-hosting portal 160. Computer 150 sends user preferences to web-hosting portal 160 through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and receives digital data from modem 162, data that is then transferred to web server 164. Modem 162 can reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends data transmissions to or receives data transmissions from one or more databases 166 via network system 168. Web server 164 includes computer applications and files for managing and storing personalization settings supplied by the client, such as door lock/unlock behavior, radio station preset selections, climate controls, custom button configurations, and theft alarm settings. For each client, the web server potentially stores hundreds of preferences for wireless vehicle communication, networking, maintenance, and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170 and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends data transmissions to or receives data transmissions from one or more communication services databases 176 via network system 180. Communication services manager 174 sends data transmissions to or receives data transmissions from one or more communication services advisors 178 via network system 180. Communication services database 176 sends data transmissions to or receives data transmissions from communication services advisor 178 via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 can provide requested information to communication services advisor 178.

In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicates with telematics unit 120 in MVCU 110 through wireless carrier system 140, communication network 142, land network 144, and web-hosting portals 160 using voice transmissions. In an alternative embodiment, communication services manager 174 communicates with telematics unit 120 in MVCU 110 through wireless carrier system 140, communication network 142, land network 144, and web hosting portals 160 using voice transmissions. Switch 172 selects between voice transmissions and data transmissions.

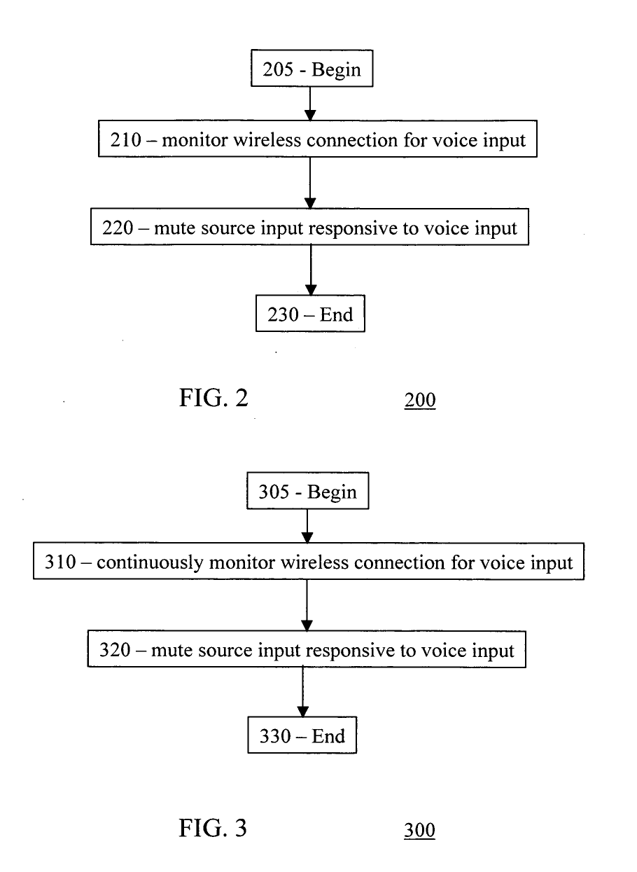

FIG. 2 illustrates a flowchart 200 representative of one embodiment of a method for configuring hold entertainment. Method 200 begins at step 205.

At step 210, method 200 monitors a wireless connection between a telematics unit (e.g. telematics unit 120 of FIG. 1) and a call center (e.g. call center 170 of FIG. 1) for a data input. As used herein, the term “data input” includes voice input. The wireless connection may be established by sending a connection request from the telematics unit to the call center, or by sending a connection request from the call center to the telematics unit. The wireless connection uses wireless carrier system 140 in one embodiment. A data input is any vocal input for a conversation between a user in the vehicle and the call center. A source input is any input other than a vocal input, and may be audio, visual or multimedia. In one embodiment, source input is the output of source device 134 illustrated in FIG. 1. For example, a source device is a radio, in one embodiment. In another embodiment, a source device is a media player, such as a CD player, MP3 player, satellite radio player, cassette player, DVD player, or other entertainment device. In one embodiment, a data input is received using microphone 130.

Monitoring for a data input, in one embodiment, includes scanning at least one predetermined frequency representative of a human voice to determine the existence of a voice. In another embodiment, a microphone at either call center 170 or in the vehicle (e.g. microphone 130) is monitored for an input. In yet another embodiment, a data input into a microphone is isolated by subtracting a source input from the microphone input to remove ambient noise from the sounds detected by the microphone. In another embodiment, voice-activated technology is utilized to receive a data input.

In one embodiment, monitoring the wireless connection is initiated at the telematics unit in response to an established connection. In another embodiment, monitoring the wireless connection is initiated by a monitor request issued by a user in MVCU 110 or an advisor (e.g. advisor 168). In one embodiment, the wireless connection is monitored in response to a button push.

At step 220, the source input is muted in response to detection of a data input. Muting the source input comprises sending a mute command from the call center to the telematics unit, in one embodiment. In another embodiment, the telematics unit itself issues a mute command. The mute command is sent using a network (e.g. network 112) within the MVCU, in one embodiment, and by a wireless connection (e.g. wireless network 140) to a source device remote from the MVCU, in another embodiment.

In one embodiment, the mute command is issued to source device 134 to stop an audio stream. In one embodiment, the mute command is issued to source device 134 to pause an audio stream. For example, if the source input results from a media player, such as a CD player, the mute command comprises a “stop” command or a “pause” command, in alternate embodiments. In another embodiment, the telematics unit interrupts the signal to the speakers (e.g. speakers 132). In another embodiment, a mute command merely reduces the volume of the signal played by the speakers by a predetermined amount. In one embodiment, the volume reduction resulting from a mute command is 5 decibels. In another embodiment, the volume reduction resulting from a mute command is 10 decibels. In yet another embodiment, a mute command affects the signal sent to the speakers.

Method 200 ends at step 230.

FIG. 3 illustrates a flowchart 300 representative of one embodiment of a method for configuring hold entertainment. Method 300 begins at step 305.

At step 310, method 300 continuously monitors a wireless connection between a telematics unit and a call center for a data input. Monitoring a wireless connection is implemented as in step 210. In method 300, the wireless connection is continuously monitored for a data input. In one embodiment, the wireless connection is monitored until the connection ends or is terminated.

At step 320, a source input is muted in response to detection of a data input. In one embodiment, step 320 is implemented as in step 220.

For example, if a data input is detected immediately upon establishing a connection, the source input is muted. The method continues to monitor the wireless connection and, for example, 45 seconds after initiation of the connection, no data input is detected. In response to the failure to detect a data input, the method returns the source input to an un-muted state. In one embodiment, the wireless connection is monitored on a predetermined frequency. In one embodiment, the predetermined frequency is configured to minimize the muting/activating of the source input. In one embodiment, the predetermined frequency is 5 times per minute. In another embodiment, the predetermined frequency is 10 times per minute. In another example, the predetermined frequency is user-defined and is configured using a web interface. In another example, the user configures the predetermined frequency using a button push received by the telematics unit. In another example, the user configures the predetermined frequency with the assistance of an advisor.

Method 300 ends at step 330.

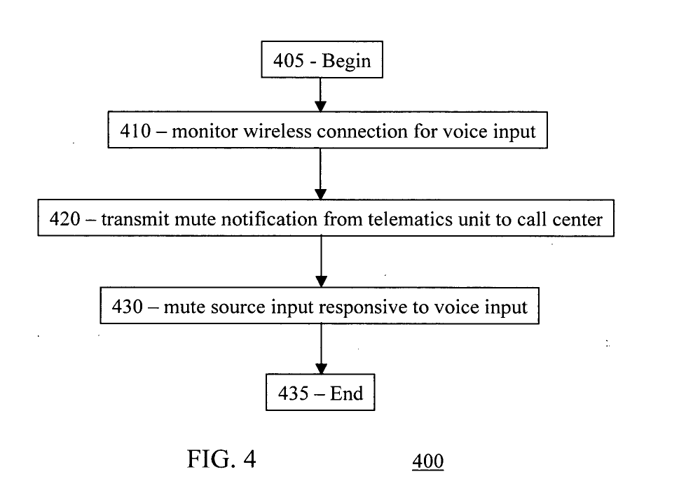

FIG. 4 illustrates a flowchart 400 representative of one embodiment of a method for configuring hold entertainment. Method 400 illustrates an embodiment of the invention wherein the telematics unit monitors a wireless connection for a data input. Method 400 begins at step 405.

At step 410, method 400 monitors a wireless connection between a telematics unit and a call center for a data input. Step 410 is implemented as step 210 illustrated in FIG. 2, in one embodiment.

At step 420, a mute notification is transmitted from the telematics unit to the call center. In one embodiment, a mute notification is a message to the call center that a source input has been muted. The mute notification, in one embodiment, is issued from the telematics unit substantially simultaneously with a mute command to a source device.

At step 430, a source input is muted in response to the detection of a data input. In one embodiment, step 430 is implemented as in step 220.

Method 400 ends at step 435.

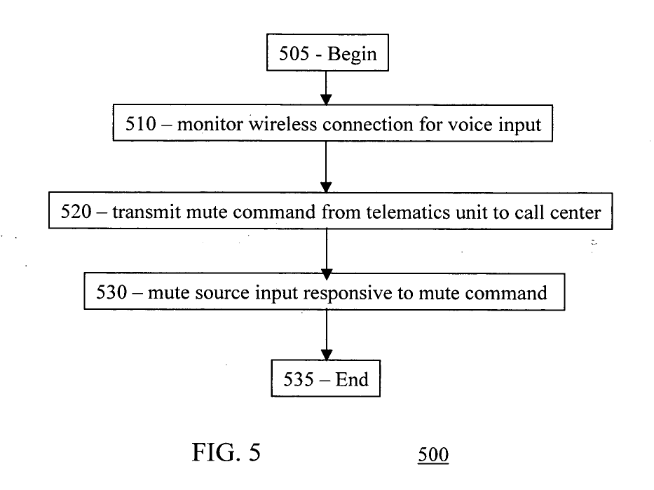

FIG. 5 illustrates a flowchart 500 representative of one embodiment of a method for configuring hold entertainment. Method 500 illustrates an embodiment of the invention wherein the call center monitors a wireless connection for a data input. Method 500 begins at step 505.

At step 510, method 500 monitors a wireless connection between a telematics unit and a call center for a data input. Step 510 is implemented as step 210 illustrated in FIG. 2, in one embodiment.

At step 520, a mute command is transmitted from the call center to the telematics unit. In one embodiment, a mute command is an instruction to the telematics unit that a source input is to be muted. The mute command, in one embodiment, is then relayed from the telematics unit to the source device.

At step 530, a source input is muted in response to the mute command. In one embodiment, step 530 is implemented as in step 220.

Method 500 ends at step 535.

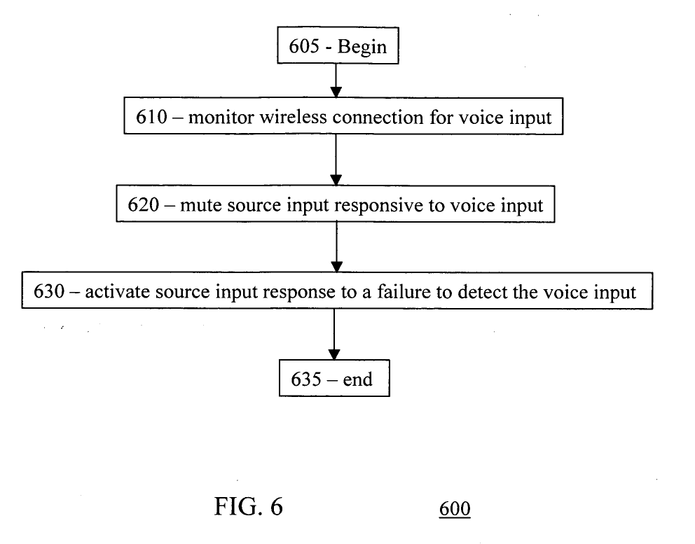

FIG. 6 illustrates a flowchart 600 representative of one embodiment of a method for configuring hold entertainment. Method 600 begins at step 605.

At step 610, method 600 monitors a wireless connection between a telematics unit and a call center for a data input. In one embodiment, step 610 is implemented as in step 210 illustrated in FIG. 2. In another embodiment, step 610 is implemented as in step 310, illustrated in FIG. 3.

At step 620, a source input is muted in response to the mute command. In one embodiment, step 620 is implemented as in step 220.

At step 630, a source input is activated in response to a failure to detect a data input. Activating a source input, in one embodiment, includes restarting a source device. In another embodiment, activating a source input includes a command to resume play from a pause or begin play from a stop. In yet another embodiment, activating a source input includes returning speakers (e.g. speakers 132) to a normal, un-muted, volume.

At step 635, method 600 ends.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for configuring hold entertainment, the method comprising:
monitoring a wireless connection between a telematics unit and a call center for a data input; and
muting a source input responsive to detection of the data input.

2. The method of claim 1 wherein the source input is selected from the group consisting of an audio signal, a video signal, and a multimedia signal.

3. The method of claim 1 wherein the data input is received at one of the call center and the telematics unit.

4. The method of claim 1 wherein monitoring the wireless connection comprises continuously monitoring the wireless connection until the connection ends.

5. The method of claim 1 wherein the connection is initiated at the telematics unit, and wherein the monitoring is initiated responsive to the connection initiation.

6. The method of claim 1 further comprising transmitting a mute command from the call center to the telematics unit via the wireless connection in response to the data input.

7. The method of claim 1 further comprising transmitting a mute notification from the telematics unit to the call center via the wireless connection in response to the data input.

8. The method of claim 1 further comprising activating the source input responsive to a failure to detect the data input.

9. A computer readable medium storing a computer program for configuring hold entertainment, the medium comprising:
computer readable code for monitoring a wireless connection between a telematics unit and a call center for a data input; and
computer readable code for muting a source input responsive to detection of the data input.

10. The medium of claim 9 wherein the source input is selected from the group consisting of an audio signal, a video signal, and a multimedia signal.

11. The medium of claim 9 wherein the data input is received at one of the call center and the telematics unit.

12. The medium of claim 9 wherein computer readable code for monitoring the wireless connection comprises computer readable code for continuously monitoring the wireless connection until the connection ends.

13. The medium of claim 9 further comprising computer readable code for transmitting a mute command from the call center to the telematics unit via the wireless connection in response to the data input.

14. The medium of claim 9 further comprising computer readable code for transmitting a mute notification from the telematics unit to the call center via the wireless connection in response to the data input

15. The medium of claim 9 further comprising computer readable code for activating the source input responsive to a failure to detect the data input.

16. A system for configuring hold entertainment comprising:
means for monitoring a wireless connection between a telematics unit and a call center for a data input; and
means for muting a source input responsive to detection of the data input.

17. The system of claim 16 wherein the source input is selected from the group consisting of an audio signal, a video signal, and a multimedia signal.

18. The system of claim 16 further comprising means for transmitting a mute notification from the telematics unit to the call center via the wireless connection in response to the data input.

19. The system of claim 16 further comprising means for transmitting a mute command from the call center to the telematics unit via the wireless connection in response to the data input.

20. The system of claim 16 further comprising means for continuously monitoring the wireless connection until the connection ends.

21. The system of claim 16 further comprising means for activating the source input responsive to a failure to detect the data input.
